(19) United States
(12) Patent Application Publication
(10) Pub. No.: US 2009/0320657 A1
(43) Pub. Date: Dec. 31, 2009

(54) Turning Machine

(75) Inventor: Glenn Jeffrey Miller, Bedford (GB)

Correspondence Address: BARNES & THORNBURG LLP, P.O. BOX 2786, CHICAGO, IL, 60690-2786, US

(73) Assignee: Cinetic Landis Grinding Limited, Yorkshire (GB)

(21) Appl. No.: 12/525,086

(22) PCT Filed: Jan. 25, 2008
(86) PCT No.: PCT/GB08/00266

§ 371 Date: Jul. 30, 2009

(30) Foreign Application Priority Data
Jan. 30, 2007 (GB) 0701721.3
Mar. 26, 2007 (GB) 0705691.4

(51) Int. Cl. B23B 5/08; B23Q 1/01

(52) U.S. Cl. 82/132

(57) ABSTRACT

A turning machine is provided for machining a workpiece with respect to a longitudinal axis (14) of the machine. The machine comprises a base (2), a headstock (10) and a tailstock (12) supported by the base for mounting respective ends of the workpiece (8) such that it is rotatable about said longitudinal axis, and a carriage (4) for carrying a tool (24) to engage with the io workpiece. The carriage is moveable parallel to said longitudinal axis along two guideways on the base, wherein the guideways are located in use on either side of and spaced horizontally from said longitudinal axis. The machine configuration seeks to reduce roll and/or pitch errors occurring as the carriage moves along the workpiece.

### FIELD OF THE INVENTION

The present invention relates to turning machines, and more particularly to roll turning machines.

### BACKGROUND TO THE INVENTION

Many roll turning machines of the type capable of machining components of a predominantly cylindrical nature, often but not exclusively for the process of diamond turning roll surfaces, are configured to include a means of holding workpieces in a workhead and, where required, a tailstock. A turning tool and means of engaging the tool with the workpiece by movement with respect to one or more axes are also provided. Various axis configurations are employed, with relative movement between the tool and workpiece achieved by transportation of the tool along and/or towards the workpiece, or movement of the workpiece relative to the tool, or movement of both tool and workpiece.

Roll turning machines may also have the capability to present more than one tool to the workpiece, sometimes with the addition of extra axes, providing translations in other linear or rotary motions.

### SUMMARY OF THE INVENTION

The present invention provides a turning machine for machining a workpiece with respect to a longitudinal axis of the machine, the machine comprising: a base; a headstock and tailstock supported by the base for mounting respective ends of the workpiece such that it is rotatable about said longitudinal axis; and a carriage for carrying a tool to engage with the workpiece, the carriage being moveable parallel to said longitudinal axis along two guideways supported by the base, wherein the guideways are located in use on either side of and spaced horizontally from said longitudinal axis. This configuration provides a stable platform for carrying the tool with its weight distributed either side of the workpiece.

A machine embodying the invention may be configured with tool-to-part motions along with a linear axis “X”, perpendicular to the face or axis of the workpiece, and along a linear axis “Z”, parallel to the face or axis of the workpiece. The addition of a “B” rotary axis enables selection of a tool for engagement with the workpiece and adjustment of a tool's angular relationship to the surface of the workpiece.

Preferably, the guideway on the side of the workpiece on which a tool is mounted in use is below said longitudinal axis, and the guideway on the other side is above said axis. More particularly, the guideways may be disposed at substantially diametrically opposed locations with respect to said longitudinal axis. This facilitates reduction of the distance between a line passing through each guideway and the location of the cutting tool, thereby reducing machining errors resulting from any roll and/or pitch motion of the carriage as it moves along a workpiece.

In a preferred embodiment, two position sensors are provided to sense the position along a respective guideway of the corresponding side of the carriage.

Advantageously, the headstock and tailstock may both be mounted for movement parallel to said longitudinal axis to accommodate different workpiece sizes, preferably on a common linear guideway. As they can both be moved, substantially symmetrical distribution of a load on the base can be achieved with different workpiece sizes.

Preferably, the headstock and tailstock are mounted on a support which is carried by the base in such a way that deformation of the base due to the weight of a workpiece mounted in the headstock and tailstock is substantially avoided. In particular, the support may be kinematically located (or semi-kinematically located) on the base.

The machine may further include an enclosure for enclosing the elements of the machine other than the base during operation of the machine so that they have a common environment. In addition, temperature control apparatus may be provided to maintain the common environment at a substantially constant temperature.

### BRIEF DESCRIPTION OF THE DRAWINGS

Embodiments of the invention will now be described by way of example with reference to the accompanying schematic drawings, wherein:

FIG. 1 is a perspective view of a roll turning machine embodying the invention;

FIG. 2 is a cross-sectional end view of the roll turning machine of FIG. 1;

FIG. 3 is a perspective view of the second support structure of the roll turning machine of FIG. 1; and

FIG. 4 is a further perspective view of the roll turning machine of FIG. 1 without a workpiece mounted in the machine.

### DETAILED DESCRIPTION OF THE DRAWINGS

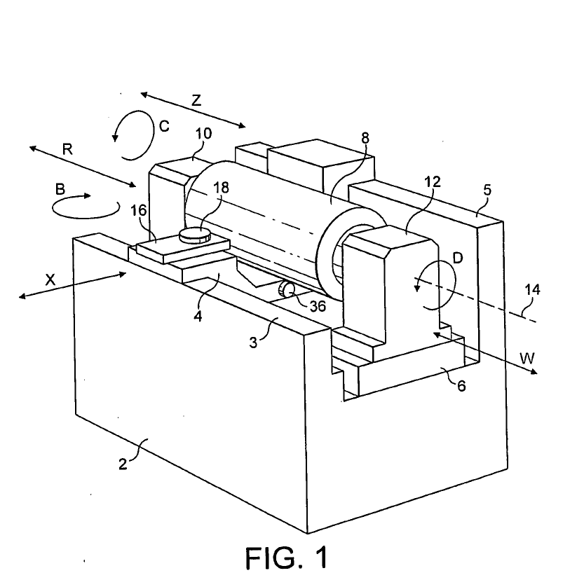

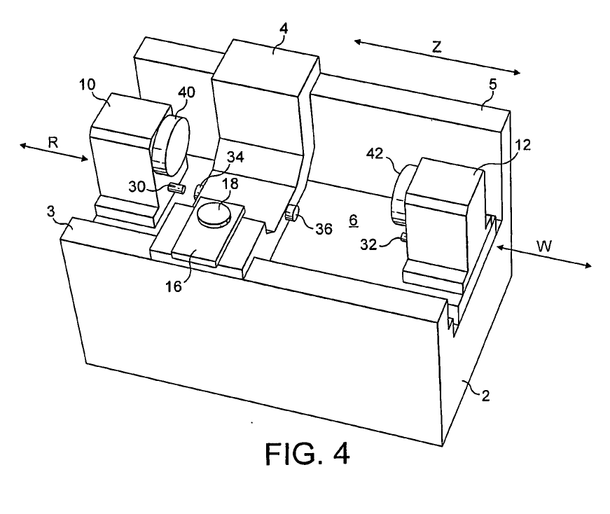

The roll turning machine shown in FIGS. 1, 2 and 4 comprises a first structure or base 2 upon which the guideways 3, 5 for the carriage 4 moveable along the Z or tool traversing axis are supported. A second structure 6 is kinematically located from the first structure 2 through interfaces that isolate the guideways of the first structure from the deforming influences of the weight of the workpiece 8.

This second structure 6 carries the headstock 10, which is moveable along the R axis whilst supporting the C spindle axis. The tailstock 12 is moveable along the W axis, is carried by the second structure and in turn supports the D axis spindle (see FIG. 3). The spindles locate the workpiece through chucking or similar retaining devices. The workhead and tailstock spindles (when required) retain the workpiece when the cutting process is in operation, while imparting rotary motion to the workpiece about longitudinal axis 14 of the machine.

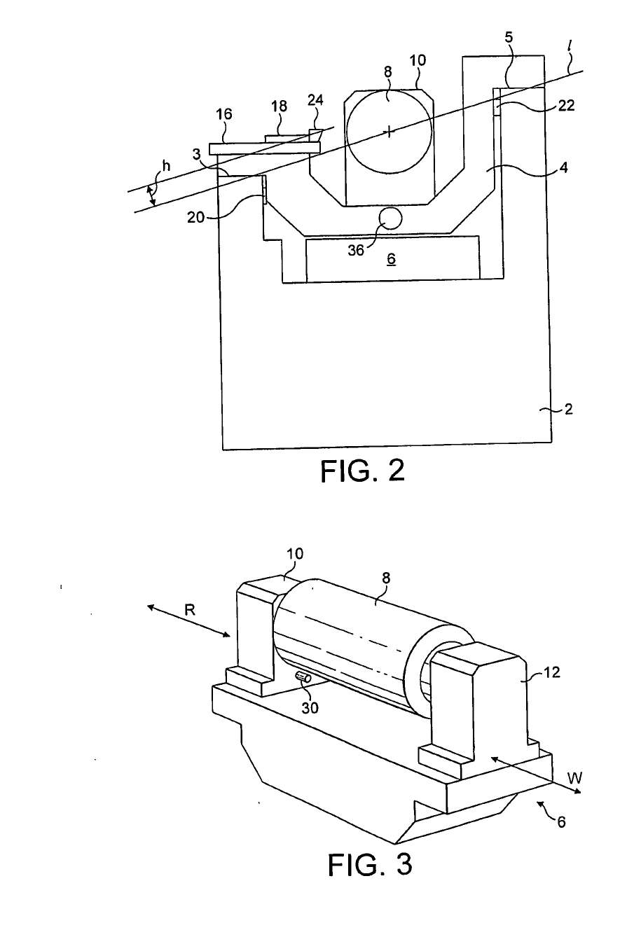

The workpiece may vary substantially in length and diameter. Although tooling can be employed to narrow the distance between the headstock 10 and the tailstock 12 to accommodate shorter workpieces, it is preferable to move both the headstock and tailstock towards each other. The tool support 16 is carried by an assembly of two linear axes, stacked upon one another, and capable of translations in the X and Z directions. A rotary tool mount 18 is provided on this assembly, and rotatable about a vertical axis “B”. The tool mount of the B axis, or table axis, has, in turn, mounting features capable of accepting the fitment of one or more toolposts which locate tools (for example cutting tool 24 in FIG. 2) for selective engagement with the workpiece.

Other machine configurations could be employed that may accommodate the workpiece and toolpost and its capability to the same effect.

The first structure 2 which carries the principal Z axis guideways is an intrinsically self-stiff structure made from an epoxy-granite stone mixture, for example. Alternative materials include cast iron or natural granite. The weight of the first structure is transmitted to the foundations through pneumatic vibration isolation feet. The Z guideways are arranged to be straight and parallel and are bolted to the first structure to support the Z carriage through hydrostatic bearings. A direct acting linear motor propels the Z axis to positions determined with reference to sensors 20, 22 in conjunction with the machine control system.

Carriage 4 transversely extends around and beneath the longitudinal axis of the machine, between the guideways 3 and 5. Guideway 3 is lower than that axis, and guideway 5 higher, with tool support 16 on the same side of the axis as guideway 3. Cutting tool 24 is horizontally aligned with the axis.

Sensors 20, 22, in the form of linear encoders for example, are mounted on each side of the carriage 4 to monitor its position along the Z axis with reference to the machine base 2. Once these sensors have been calibrated, movement of the carriage along the Z axis without any yaw error motion should yield identical position readings from the sensors. If the carriage yaws, a difference in the readings from the sensors will result, which can be employed to offset the position of the cutting tool in the Z direction dependent on its position in the X direction between the two sensors. One of the sensors is designated as a master for the purposes of calculating the offset in the Z direction.

Second structure 6 supports the C and D axis spindles on a linear guideway via rolling element or hydrostatic bearings. The guideway allows the two axes to be moved towards each other to accommodate variations in workpiece length. The arrangement is further optimised by utilising the Z carriage axis drive system to capture in turn the C axis and D axis through a system of couplings and 30, 32 on the headstock and tailstock, respectively, and corresponding clamps 34, 36 on either side of the carriage 4.

The base 2 is designed so as to ensure that the alignment of the guideways are not detrimentally affected by changes in the loading caused by movement of the Z axis. In addition, the location of the Z guide rails to the rear, above and to the front of the machine, below the workpiece axis 14 greatly reduces the errors in tool positioning induced by roll of the Z axis.

This configuration serves to minimise the height distance h (shown in FIG. 2) of the tool 24 measured perpendicularly to a line 1 passing through both the front and rear guideways. Machining errors due to roll and pitch motions by the carriage 4 along the Z axis are thereby reduced.

Intrinsic geometric accuracy of the machine axes is substantially improved by the placement of the Z bearings on the first structure and by the isolation of the axis guideways from the effects of the workpiece loading.

The location of the Z bearings above and below the centre line of the C and D axes minimises the effects of roll error caused variation in geometry of the guideways. Conventional roll turning machines place the guideways at a position which is convenient to the fabrication of the machine bed. This design overcomes the mounting difficulties and reduces the offset error caused when roll is projected at the height of the cutting tool.

Both the C axis, headstock spindle 40 and the D axis, tailstock spindle 42 bearing systems are oil hydrostatic and designed to support the weight of the workpiece as it rotates about its axis. The C spindle contains a servo motor and rotary encoder which simultaneously maintain the position and velocity of the workpiece in conjunction with the machine control system. The D axis spindle is passive and designed to be thrustless to avoid over-constraining the workpiece.

The method of isolation of the second structure 6, which carries the headstock and tailstock spindles, is designed to minimise the magnitude of distortion of the principle machine guideways due to workpiece loading. A further improvement is made by arranging the headstock and tailstock to move towards each other on a precision guideway designed to maintain symmetrical loading of the second supporting structure.

The arrangement of the C axis headstock and D axis tailstock on a co-linear guideway allows the two machine elements to be moved towards each other and maintain a symmetrical load on the second supporting structure. The balance of the machine is maintained further ensuring a minimum contribution by workpiece loading to geometric errors.

The C axis and D axis, conveniently mounted on the common linear guideways, can be attached to the Z carriage via couplings and clamps to set the working location of the spindles to accommodate a range of workpiece lengths.

The Z axis carriage has a short pair of linear guideways to carry the tool support 16 via a second set of hydrostatic bearings. A motor for moving the tool support is provided with its stator mounted between the X bearings and is arranged to propel the X tool support axis towards the workpiece. A linear encoder determines the position of the tool support in a similar manner to the Z axis through use of the machine control system.

The tool mount, B axis 18 comprises a stator assembly fixed to the tool support and a rotating central spindle carrying a plattern suitable for mounting a toolpost. The arrangement of the bearing in the B axis can optionally be designed as hydrostatic, aerostatic or rolling element, depending on the desired accuracy of rotation and of the radial and axial stiffness. In the illustrated embodiment, a high stiffness, high accuracy hydrostatic bearing arrangement is preferred. A high resolution grating based encoder is used in combination with a torque motor and the machine control system to determine the angular position of the tool mount. The angular position of the table may optionally be determined by a manually indexing mechanism or by a full servo position control.

Roll machining operations do not require the stroke of the X axis to reach beyond the centre line of the C and D axes. The design of the X bearing arrangement and the supporting Z carriage is consequently more compact.

The machine in its entirety is housed in a containment (not shown in the Figures) that is supported by the first structure 2. The first structure is mounted on system of feet which supports the weight of the entire machine whilst isolating the assembly from mechanical vibrations that would otherwise disturb the integrity of the relationship between the cutting tool and the workpiece.

Machines for roll turning are conventionally large making containment difficult. The design described here is extremely compact enabling a single and complete cover assembly to be utilised. The volume enclosed is capable of supporting its own microclimate which simplifies the task of controlling the geometric stability of the machine. Temperature outside the microclimate may vary substantially, but the contained structure is maintained at a substantially constant temperature with relative ease.

It will be appreciated that references herein to orthogonal or parallel relative orientations are to be interpreted as defining substantially orthogonal or parallel relationships between components within practical tolerances.

1-13. (canceled)

14. A turning machine for machining a workpiece with respect to a longitudinal axis of the machine, the machine comprising: a base; a headstock and tailstock supported by the base for mounting respective ends of the workpiece such that it is rotatable about said longitudinal axis; and a carriage for carrying a tool to engage with the workpiece, the carriage being movable parallel to said longitudinal axis along two guideways supported by the base, wherein the guideways are spaced horizontally from said longitudinal axis and are disposed at substantially diametrically opposed locations with respect to said longitudinal axis.

15. A machine of claim 1 wherein the guideway on the side of the workpiece on which a tool is mounted in use is below said longitudinal axis, and the guideway on the other side is above said axis.

16. A machine of claim 1 including two position sensors for sensing the position along a respective guideway of the corresponding side of the carriage to enable detection of any yaw error in the motion of the carriage.

17. A machine of claim 1 wherein the headstock and tailstock are both mounted for movement parallel to said longitudinal axis to accommodate different workpiece sizes.

18. A machine of claim 4 wherein the headstock and tailstock are mounted on a common linear guideway.

19. A machine of claim 4 wherein the headstock and tailstock can be selectively coupled to the carriage to enable the carriage to alter their respective locations.

20. A machine of claim 1 wherein the headstock and tailstock are mounted on a support which is carried by the base in such a way that deformation of the base due to the weight of a workpiece mounted in the headstock and tailstock is substantially avoided.

21. A machine of claim 7 wherein the support is kinematically located on the base.

22. A machine of claim 7 wherein the support is semi-kinematically located on the base.

23. A machine of claim 1 including an enclosure supported by the base for enclosing the elements of the machine in claim 1 other than the base during operation of the machine so that they have a common environment.

24. A machine of claim 10 for including temperature control apparatus for maintaining the common environment at a substantially constant temperature.

25. A machine of claim 1 in the form of a roll turning machine.
